(19) United States
(12) Patent Application Publication
(10) Pub. No.: US 2016/0311338 A1
(43) Pub. Date: Oct. 27, 2016

(54) Device and Method for the Supply of Emergency Power to at Least One Electrical Load

(71) Applicant: OMICRON Electronics GmbH, Klaus (AT)

(72) Inventor: Ulrich Klapper, Rankweil (AT)

(21) Appl. No.: 15/202,076

(22) Filed: Jul. 5, 2016

Related U.S. Application Data
(63) Continuation of application No. PCT/EP2014/079108, filed on Dec. 23, 2014.

(30) Foreign Application Priority Data
Jan. 2, 2014 (AT) A 50001/2014

(51) Int. Cl. B60L 11/18

(52) U.S. Cl. CPC B60L 11/1842; B60L 11/1811; B60L 11/1818; B60L 2230/16; B60L 2210/44

(57) ABSTRACT

An emergency power supply device for providing an emergency power supply for at least one electrical load is configured to couple to a discharge interface of an electric vehicle. The emergency power supply device is equipped to provide the emergency power supply for the at least one electrical load by discharging a traction battery of the electric vehicle.

### CROSS-REFERENCE TO RELATED APPLICATIONS

This application:
is a continuing application, under 35 U.S.C. §120, of copending International Application No. PCT/EP2014/079108, filed Dec. 23, 2014, which designated the United States and was not published in English; and
claims the priority, under 35 U.S.C. §119, of Austrian Patent Application No. A50001/2014, filed Jan. 2, 2014;
   the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present systems, apparatuses, and methods lie in the field of emergency power to at least one electrical load.

### BACKGROUND OF THE INVENTION

Devices for supplying electrical loads in the event of a power failure exist in the art. Supplying electrical loads in the event of a power failure is frequently known as emergency power generation. Typical examples include diesel generator sets or other fuel generator sets in which a fuel is burned to provide a supply of electrical energy. Further examples of devices for the supply of emergency power include battery systems. Battery-based devices for the supply of emergency power can be used, for example, for an uninterrupted power supply (UPS) and are, therefore, attractive. The energy storage of such devices often represents a significant cost factor.

There is a demand for devices and processes to supply emergency power to at least one load, which can be realized more simply and efficiently in comparison to conventional battery-based emergency power supply units. There is a demand for devices and processes of this type that are not reliant on a battery that is reserved for the emergency power supply and can be used only for an emergency power supply.

Thus, a need exists to overcome the problems with the prior art systems, designs, and processes as discussed above.

### SUMMARY OF THE INVENTION

The systems, apparatuses, and methods described provide emergency power supply device and a process for providing an emergency power supply that overcome the hereinafore-mentioned disadvantages of the heretofore-known devices and methods of this general type and that provide such features where a traction battery of an electric vehicle can be used as an energy storage for the emergency power supply. An emergency power supply device, which can be configured as a portable device, can then be selectively coupled to a discharge interface of the electric vehicle only when an emergency power supply is provided and does so through the emergency power supply device in the event of a failure of an electrical mains. When used herein regarding a couple, “selectively” means that the couple is selected to be coupled (i.e., connected) or selected to be uncoupled (i.e., disconnected). When used herein regarding the supply or delivery of energy, “selectively” means that the supply is selected to be supplying energy or is selected to not be supplying energy.

Electric vehicles are becoming technically and economically more important. The term electric vehicles refers to vehicles with an electric drive. During operation, the electric drive is supplied with energy from the traction battery. The electric vehicle can be a fully electric vehicle or a hybrid vehicle that, in addition to the electric drive, comprises at least one further drive and an energy storage system associated with the further drive.

The traction battery represents an important and expensive component of the electric vehicle. According to exemplary embodiments, the traction battery can be used selectively for supplying emergency power in the event of a failure of an electrical mains. This allows users to dispense with accumulators that are installed in fixed manner in a building and that can only be used for an emergency power supply or a reduction in the storage capacity and, therefore, the costs, of such accumulators.

An emergency power supply device for providing an emergency power supply for at least one electrical load according to an exemplary embodiment is configured to couple to a discharge interface of an electric vehicle. The emergency power supply device is equipped to provide the emergency power supply for the at least one electrical load by discharging a traction battery of the electric vehicle.

The emergency power supply device can be equipped to be coupled between the discharge interface of the electric vehicle and the at least one electrical load. The traction battery, which is provided in any case for driving, is additionally used as an energy storage to selectively supply emergency power to an electrical load or a plurality of electrical loads.

The emergency power supply device can comprise an interface outputting a discharge command to the electric vehicle. The emergency power supply device can control the discharge procedure in this way.

The emergency power supply device can be equipped to generate at least one further discharge command that depends upon which electrical load is connected to an output of the emergency power supply device.

The discharge interface of the electric vehicle can be a combined charge/discharge interface. The interface through which the emergency power supply device outputs the discharge command can be equipped to couple to the charge/discharge interface of the electric vehicle. The emergency power supply device can be equipped to transmit the discharge command as a power line communication over at least one electrical line of the charge/discharge interface, by which energy is also transmitted to the traction battery or energy is transmitted from the traction battery for the purpose of charging and discharging the traction battery.

The interface through which the emergency supply device outputs the discharge command can be equipped to couple to a data interface of the electric vehicle that is different from the discharge interface of the electric vehicle. The data interface can be a test interface.

The emergency power supply device can be equipped to generate the discharge command according to a vehicle-to-grid (“V2G”) protocol.

The emergency power supply device can comprise an inverter that is equipped to receive a discharge current of the traction battery and to generate an alternating current to provide the emergency power supply. The inverter can be disposed in a portable housing of the emergency power supply device. If needed, this facilitates the provision of an emergency power supply.

The emergency power supply device can comprise a socket that is connected to an output of the inverter and that is equipped to connect to a mains plug of the at least one electrical load. The socket can be disposed on a portable housing of the emergency power supply device. The socket can be connected to the portable housing of the emergency power supply device through a line.

The emergency power supply device can comprise an energy storage. The energy storage can be equipped to buffer electrical energy discharged from the traction battery and to deliver it selectively to the at least one load. The emergency power supply device can be equipped to charge the energy storage while a discharge current flows from the traction battery to the emergency power supply device, and to discharge the energy storage to the at least one electrical load while the discharge current from the traction battery to the emergency power supply device is temporarily interrupted or decreased. An adaptation to the power consumption of the at least one electrical load can take place through the energy storage. The emergency power supply device can be equipped to generate further discharge commands for temporarily stopping the discharge procedure depending on a charge status of the energy storage and to output these discharge commands to the electric vehicle. The emergency power supply device can be equipped so that the energy storage supplies energy to the at least one electrical load selectively when a discharge current of the traction battery is temporarily decreased.

The energy storage can be connected to an input of the inverter.

The at least one electrical load can be connected directly to the emergency power supply device. This enables individual loads to be supplied without having to install a building mains or another electrical mains for an emergency power supply.

The emergency power supply device can be equipped to supply emergency power directly to the at least one load without the emergency power flowing through a building mains.

The emergency power supply device can be equipped to provide the emergency power supply for the at least one electrical load without mains impedance monitoring. Because the emergency power supply device supplies an electrical load with energy on the output side, for example through a socket, it is possible to dispense with mains impedance monitoring. It is possible to ensure the safety of a user through the design of the mains socket.

The emergency power supply device can be a mobile device, in particular, a portable device.

The emergency power supply device can comprise a housing in which an inverter is disposed. The housing can be mobile, in particular, portable.

At least one control device generating the discharge command can be disposed in the housing. The control device can control or regulate the inverter depending on a load at the output of the emergency power supply device. The control device can generate at least one further discharge command depending on the load at the output of the emergency power supply device and provide it to the electric vehicle.

A system according to an exemplary embodiment comprises at least one electric vehicle having a traction battery, at least one electrical load and at least one emergency power supply device according to an exemplary embodiment. The emergency power supply device is equipped to be coupled to the at least one electric vehicle and the at least one electrical load in the event of a failure of an electrical mains in order to provide emergency power for the at least one load.

The at least one electrical load can be a household appliance. The household appliance can be directly connectable to the emergency power supply device. The at least one electrical load can be, for example, a refrigerator or a freezer.

The at least one electrical load can be a lamp. The at least one electrical load can be emergency lighting.

The electric vehicle can have a charge/discharge interface. The electric vehicle can be equipped to optionally feed energy back into an electrical mains, or, in the event of a failure of the electrical mains, to supply energy to the at least one electrical load, by way of the charge/discharge interface.

The electric vehicle can be equipped to receive a discharge command from the emergency power supply device by way of the charge/discharge interface. The electric vehicle can be equipped to receive the discharge command in a power line communication over a line of the charge/discharge interface, through which energy is also transmitted for charging or discharging the traction battery.

The electric vehicle can have a data interface that is separate from the charge/discharge interface and can be equipped to receive the discharge command from the emergency power supply device through the data interface.

The electric vehicle can be a fully electric vehicle or a hybrid vehicle.

In a process for providing an emergency power supply for at least one electrical load according to an exemplary embodiment, an emergency power supply device is coupled to a discharge interface of an electric vehicle. The at least one electrical load is supplied by the emergency power supply device by discharging a traction battery of the electric vehicle.

The emergency power supply device can be configured as an emergency power supply device according to an exemplary embodiment.

To discharge the traction battery, a discharge command can be generated and outputted through an interface of the emergency power supply device.

To discharge the traction battery, the emergency power supply device can generate at least one further discharge command depending on which electrical load is connected to an output of the emergency power supply device.

The discharge command can be transmitted to the electric vehicle through the charge/discharge interface of the electric vehicle.

The discharge command can be transmitted through a data interface of the electric vehicle that is different from the charge/discharge interface.

The discharge command can be generated according to a vehicle-to-grid protocol.

The supply to the at least one load can comprise a DC-AC conversion through the emergency power supply device.

A mains plug of the at least one load can be connected directly to a socket of the emergency power supply device to supply the at least one load. This enables individual loads to be supplied without having to install a building mains or other electrical mains for an emergency power supply.

The emergency power supply device can supply emergency power directly to the at least one load without the emergency power flowing through a building mains.

The emergency power supply for the at least one load can take place without mains impedance monitoring.

The emergency power supply device can be a mobile device, in particular, a portable device.

The at least one electrical load can be a household appliance. The at least one electrical load can be a lamp.

In the course of the process, a charge/discharge interface of the electric vehicle can be uncoupled from an electrical mains before it is connected to the emergency power supply device for supplying emergency power.

The process can comprise a buffering of energy in an energy storage of the emergency power supply device. A discharge current of the traction battery can be changed between several discrete values in time-dependent manner. Depending on which of the several discrete values the discharge current has at the time, the energy storage of the emergency power supply device can be charged by the traction battery or discharged to the at least one electrical load.

The electric vehicle can be a fully electric vehicle or a hybrid vehicle.

With the foregoing and other objects in view, there is provided, a an emergency power supply device for providing emergency power for at least one external electrical load from an electric vehicle having a traction battery connected to a discharge interface, the emergency power supply device comprising a power controller, a vehicle interface shaped to couple to the discharge interface of the electric vehicle and, when electrically coupled thereto, to receive power from the traction battery through the discharge interface, the vehicle interface electrically connected to the power controller, a power supply circuit electrically connected to at least one of the power controller and to the vehicle interface, and an output electrically connected to at least one of the power controller, the vehicle interface, and the power supply circuit to supply output power to the external electrical load when electrically connected to the output, the power supply circuit controlling the supply of power sent to the output.

In accordance with another feature, there is provided an inverter electrically connected to at least one of the power controller and the output and configured to receive a discharge current of the traction battery and to generate an alternating current at the output to provide an emergency power supply.

In accordance with a concomitant feature, the inverter has an output and which further comprises a mains socket electrically connected to the output of the inverter and shaped to connect to a mains plug of the at least one electrical load.

Devices, processes and systems according to exemplary embodiments enable the provision of an emergency power supply using the traction battery of the electric vehicle as an energy storage. In the event of a partial or total failure of an electrical mains, for example, a building mains or an energy grid of a supplier, the emergency power supply device can be selectively connected to the electric vehicle and a single electrical load or a plurality of electrical loads to supply these with energy. It is thereby possible to reduce the storage-capacity requirements of accumulators that are installed in fixed manner in a building for supplying emergency power.

Although the systems, apparatuses, and methods are illustrated and described herein as embodied in emergency power supply devices and processes for providing an emergency power supply, they are, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems, apparatuses, and methods.

Additional advantages and other features characteristic of the systems, apparatuses, and methods will be set forth in the detailed description that follows and may be apparent from the detailed description or may be learned by practice of exemplary embodiments. Still other advantages of the systems, apparatuses, and methods may be realized by any of the instrumentalities, methods, or combinations particularly pointed out in the claims.

Other features that are considered as characteristic for the systems, apparatuses, and methods are set forth in the appended claims. As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one of ordinary skill in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the systems, apparatuses, and methods of the invention that are regarded as novel, it is believed that the systems, apparatuses, and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems, apparatuses, and methods. Advantages of embodiments of the systems, apparatuses, and methods will be apparent from the following detailed description of the exemplary embodiments thereof, which description should be considered in conjunction with the accompanying drawings in which:

FIG. 1 is a schematic illustration of an exemplary embodiment of a system having an emergency power supply device;

FIG. 2 is a flow chart of a process according to an exemplary embodiment;

FIG. 3 is a flow chart of a process according to a further exemplary embodiment; and

FIG. 4 is a schematic illustration of a system having an emergency power supply device according to a further exemplary embodiment.

### DETAILED DESCRIPTION OF THE EMBODIMENTS

As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one skilled in the art to variously employ the systems, apparatuses, and methods in virtually any appropriately detailed structure. Further, the terms and phrases used herein are not intended to be limiting but, rather, to provide an understandable description of the systems, apparatuses, and methods. While the specification concludes with claims defining the features of the systems, apparatuses, and methods that are regarded as novel, it is believed that the systems, apparatuses, and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems, apparatuses, and methods will not be described in detail or will be omitted so as not to obscure the relevant details of the systems, apparatuses, and methods.

Before the systems, apparatuses, and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, and top/bottom. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

It will be appreciated that embodiments of the systems, apparatuses, and methods described herein may be comprised of one or more conventional processors and unique stored program instructions that control the one or more processors to implement, in conjunction with certain non-processor circuits and other elements, some, most, or all of the functions of the devices and methods described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system or programmable device. A “program,” “software,” “application,” “computer program,” or “software application” may include a subroutine, a function, a procedure, an object method, an object implementation, an executable application, an applet, a servlet, a source code, an object code, any computer language logic, a shared library/dynamic load library and/or other sequence of instructions designed for execution on a computer system.

Herein various embodiments of the systems, apparatuses, and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

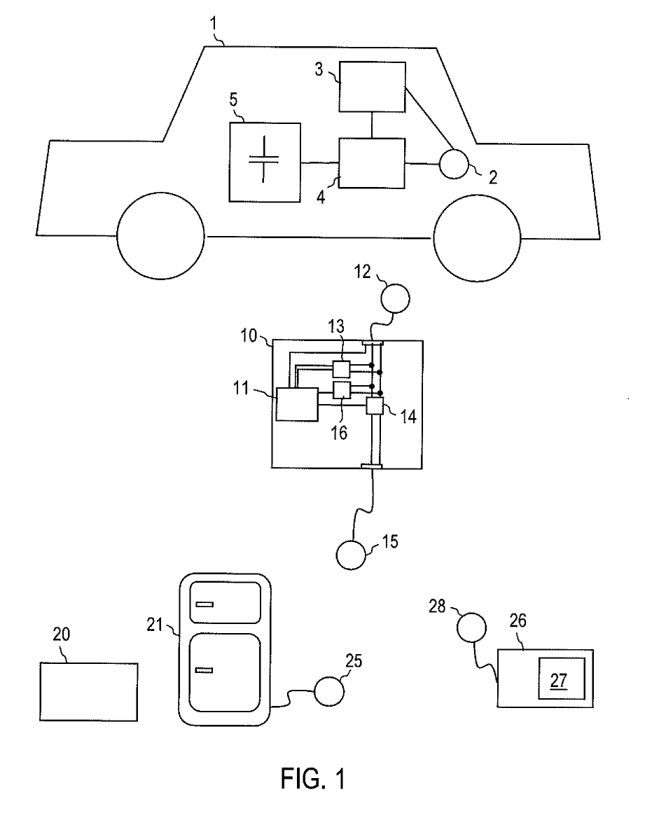

Described now are exemplary embodiments. Referring now to the figures of the drawings in detail and first, particularly to FIG. 1, there is shown a first exemplary embodiment of a system comprising an electric vehicle 1 and an emergency power supply device 10. The electric vehicle 1 comprises an electric drive (not illustrated) that is supplied with energy by the traction battery 5. The electric vehicle 1 can be a fully electric vehicle. Alternatively, the electric vehicle 1 can be a hybrid vehicle, which comprises at least one further drive in addition to the electric drive and which comprises at least one further energy storage system for the further drive in addition to the traction battery 5. The traction battery 5 can comprise a plurality of interconnected accumulator cells or blocks as energy storages or energy stores for driving the electric vehicle 1.

To charge the traction battery 5, an electric vehicle 1, which is configured as a fully electric vehicle, has to be temporarily connected to an electrical mains 20 through a charge plug in order to charge the traction battery of the electric vehicle 1. An electric vehicle 1 that is configured as a hybrid vehicle can also be temporarily connected to the electrical mains 20 through the charge plug to charge the traction battery 5 of the electric vehicle 1. In self-sufficient hybrid vehicles, the traction battery 5 can be charged through the internal combustion engine or when braking (so-called recuperation).

The electric vehicle 1 can be configured such that the traction battery 5 is dischargeable. The electric vehicle 1 can be equipped for discharging the traction battery 5 in a V2G procedure in which the traction battery 5 can be discharged into the electrical mains 20. As described in detail below, an emergency power supply device 10 can be connected to the electric vehicle to supply at least one electrical load 21 with energy in the event of a mains failure and to thereby discharge the traction battery 5 not into the electrical mains 20 but through the emergency power supply device 10.

The electric vehicle 1 can have charge/discharge electronics 4 that are equipped to optionally charge or discharge the traction battery 5 through a charge/discharge interface. The electric vehicle 1 has a discharge interface through which the traction battery 5 can be discharged. The discharge interface can be configured as a combined charge/discharge interface. The combined charge/discharge interface can be configured as a charge/discharge plug 2. The charge/discharge plug 2 serves as an interface with which the electric vehicle 1 can be connected a charging station of the electrical mains 20 or, for supplying emergency power, to the emergency power supply device 10. The vehicle 1 can have control electronics 3 that can comprise an on-board power supply with a control device or a plurality of control devices and/or an on-board computer.

The emergency power supply device 10 can be constructed separately from the electrical mains 20 so that the emergency power supply device 10 does not also have to be coupled to the electrical mains 20 to supply the at least one electrical load 21. The electrical mains 20 can be a building mains. The at least one electrical load 21 is a different device from the electric vehicle 1. The at least one electrical load 21 can comprise a household appliance, for example, a refrigerator or a freezer, and/or at least one lamp. The at least one electrical load 21 has a mains plug 25 through which it can be connected to a mains socket of the electrical mains 20.

To supply the at least one electrical load 21, the emergency power supply device 10 is equipped to be connected to the electric vehicle 1 and the at least one electrical load 21. The emergency power supply device 10 has an output 15. The mains plug 25 of the electrical load 21 can be connected to the output 15. The output 15 of the emergency power supply device 10 can be configured as a mains socket.

The emergency power supply device 10 can be equipped to trigger a discharge procedure of the traction battery 5 of the electric vehicle 1. The emergency power supply device 10 has an interface 12 that can be releasably coupled to the charge/discharge plug 2 of the electric vehicle 1. The interface 12 can comprise a configuration of electrical contacts and/or mechanical connecting elements, which corresponds to the configuration of electrical contacts and/or mechanical connecting elements of a charging station for charging the traction battery 5 of the electric vehicle through the charge/discharge plug 2.

To supply emergency power to the at least one electrical load 10, the interface 12 of the emergency power supply device 10 is connected to the charge/discharge plug 2. The emergency power supply device 10 triggers a discharge procedure. To this end, the emergency power supply device 10 can generate a discharge command that is relayed to the electric vehicle 1 either through the charge/discharge plug 2 or an interface of the electric vehicle 1 that is separate therefrom.

The traction battery 5 of the electric vehicle can be discharged in response to the discharge command. During the discharge procedure, the emergency power supply device 10 can generate at least one further discharge command to control or regulate the discharge procedure. For example, the emergency power supply device 10 can control or regulate a current strength of a discharge current of the traction battery 5 and/or a discharge current capacity of the traction battery 5 depending on the electrical load 21 at the output 15 of the emergency power supply device 10. To this end, the emergency power supply device 10 can relay the at least one further discharge command to the electric vehicle 1 through the charge/discharge plug 2 or an interface of the electric vehicle 1 that is separate therefrom.

At least during the discharge procedure that is triggered by the discharge command, the emergency power supply device 10 can generate an alternating current and provide it to the at least one electrical load 21. The emergency power supply device 10 can control or regulate an output current or an output voltage at the output 15. The emergency power supply device 10 can comprise an inverter 14, which can be controlled by a control device 11 such that an alternating voltage is provided at the output 15 of the emergency power supply device 10, the frequency and nominal amplitude of which corresponds to the alternating voltage of the electrical mains 20 to which the electrical load 21 is connected during normal operation.

The emergency power supply device 10 can have a control device 11 that is equipped to control the emergency power supply device 10 during operation. The control device 11 can comprise one or more processors, microprocessors, controllers, microcontrollers, application-specific integrated circuits (ASICs) and/or other integrated semiconductor circuits or a combination thereof.

The control device 11 can be equipped to generate the discharge command for triggering a discharge procedure and, optionally, further discharge commands for controlling or regulating a discharge current. The control device 11 can be equipped to control the inverter 14. The control device 11 can be equipped to generate control signals for at least one controllable component of the inverter 14 in a control loop, for example, a clocked circuit breaker of the inverter 14. The control device 11 can be equipped to generate the control signals for the at least one controllable component of the inverter such that an alternating voltage at the output 15 of the emergency power supply device 10 has a frequency and amplitude that corresponds to the mains voltage of the electrical mains 20 and that is provided to supply the at least one load 21.

The control device 11 can be equipped to carry out automatic load recognition and, therefore, to recognize a load at the output 15 of the emergency power supply device. The control device 11 can be equipped to automatically detect a power consumption of the at least one load 21. To this end, the control device 11 can monitor a voltage or a current on a secondary side of the inverter 14. The control device 11 can be equipped to control the inverter 15 depending on a power consumption of the at least one load 21.

The control device 11 can be equipped to provide an alternating voltage at the output 15 without mains impedance monitoring. It is possible to achieve protection for users through the design of the output 15, which can be in the form of a mains socket, for example.

At least during the discharge procedure, the emergency power supply device 10 can be supplied with energy through the interface 12 and the charge/discharge plug 2 of the electric vehicle 1. The emergency power supply device 10 can be equipped to be supplied with energy by the electric vehicle 1 through the interface 12 as soon as the discharge command that triggers the discharge procedure is generated. The emergency power supply device 10 can have a supply circuit 13 that is coupled to the interface 12. The supply circuit 13 can be equipped to generate a supply voltage for the monitoring unit 11 and/or other elements of the emergency power supply device 10 from the energy flow that flows through the charge/discharge plug 2 of the electric vehicle 1 to the emergency power supply device 10 during the discharge procedure.

The emergency power supply device 10 can be configured as a mobile device. The emergency power supply device 10 can have a housing that is portable. The inverter 14 and the control device 11 can be in the housing.

The emergency power supply device 10 can have a user interface. The user interface can be on the housing of the emergency power supply device 10. An emergency power supply can be initiated and optionally configured through the user interface. For example, the emergency power supply device 10 can be reconfigurable for several frequencies of the alternating voltages at the output 15 and/or for several nominal output voltages. This enables the emergency power supply device 10 to be used in different countries where the mains voltage has different frequencies and/or nominal amplitudes.

The discharge command for triggering the discharge procedure and possible further discharge commands with which a discharge procedure is controlled, for example, can be provided to the electric vehicle in various ways. In the embodiment shown in FIG. 1, the interface 12 of the emergency power supply device 10 has at least one connection through which discharge commands can be transmitted. The charge/discharge plug 2 of the electric vehicle has a corresponding connection for receiving the discharge commands. The discharge commands can be further processed by the control electronics 3 and/or the charge/discharge electronics 4.

The discharge commands can each be generated according to a V2G protocol. The evaluation of corresponding discharge commands of the V2G protocol is implemented in the electric vehicle 1 for V2G functions. The discharge command with which the discharge procedure of the traction battery 5 is triggered for the emergency power supply can be the same control command with which the electric vehicle 1 is induced to feed energy back into the electrical mains 20 in a V2G operation. Alternatively, the discharge command with which the discharge procedure of the traction battery 5 is triggered for the emergency power supply can be a control command that is reserved for the emergency power supply and that is not used for normal V2G applications. For example, the discharge command with which the discharge procedure of the traction battery 5 is triggered for the emergency power supply can enable a more extensive discharging of the traction battery 5 than control commands for the discharge procedure in conventional V2G applications. The electric vehicle 1 can be equipped to implement the discharge command and, depending on the discharge command, to execute different discharge procedures for the emergency power supply and for conventional V2G applications in which energy is fed back into the electrical mains 20 and not directly to the load 21 through the emergency power supply device 10.

In the embodiment described with reference to FIG. 1, the vehicle is stimulated through the same interface for activating the battery discharge procedure as that used in V2G applications. In addition to the connections that serve for the actual energy flow, the charge/discharge plug 2 can also have further connections for transmitting commands or other information. In exemplary embodiments, these connections can be used to trigger a discharge procedure. Processes such as a power line communication (PLC) can be used here. In this case, it is possible to implement a power line communication through signalling pins.

The emergency power supply device 10 can comprise an energy storage 16. The energy storage 16 can comprise one or more accumulators. The energy storage 16 can comprise one or more capacitors. The energy storage 16 can be used to adapt an output capacity of the emergency power supply device 10 to the power consumption of the at least one electrical load 21. For example, it is possible for the discharge current and/or the discharge capacity of the traction battery 5 to only be alterable between several discrete values. The electric vehicle 1 can be equipped, for example, such that either only a discharge current with a predefined discharge current strength is flowing or the discharge current has a current strength of zero. By selectively charging and discharging the energy storage 16, a time-based mean value of the output capacity of the electric vehicle 1 can be adapted to the power consumption of the at least one electrical load 21. The emergency power supply device 10 having the energy storage 16 provides the necessary buffering. A first time interval in which a discharge current with a first discharge current strength flows to the emergency power supply device 10 can alternate with a second time interval in which a discharge current with a second discharge current strength flows to the emergency power supply device 10. The second discharge current strength is lower than the first discharge current strength and can also be zero, for example. In the first time interval, a first proportion of the discharge current of the traction battery 5 can be fed to the input of the inverter 14, while a second proportion of the discharge current of the traction battery 5 can be used to charge the energy storage 16. The energy storage 16 can be discharged in the second time interval. A discharge current of the energy storage 16 can be fed to the input of the inverter 14 in the second time interval. First time intervals, in which the energy storage 16 is charged, and second time intervals, in which the energy storage is discharged, can follow each other alternately.

The emergency power supply device 10 can be equipped to control a time-dependent sequence of different discharge currents of the traction battery 5. The emergency power supply device 10 can generate corresponding discharge commands and output them to the electric vehicle 1 to change the discharge current of the traction battery 5. The control device 11 can be equipped to monitor the charge status of the energy storage 16. The control device 11 can be equipped to generate a discharge command through which the discharge current of the traction battery 5 is increased and output it through the interface 12, and to control the energy storage 16 so that it stores energy. The control device 11 can be equipped to generate a discharge command through which the discharge current of the traction battery 5 is decreased and output it through the interface, and to control the energy storage 16 so that it provides energy to the input of the inverter 14. It is thereby possible for a time-based mean value of the discharge capacity of the traction battery 5 to be adapted to the power consumption of the at least one electrical load 21. The energy storage 16 enables such an adaptation even if the electric vehicle 1 can only provide a few discrete discharge current strengths or current capacities because it is possible to buffer energy in the energy storage 16.

The emergency power supply device 10 can be used in combination with at least one further emergency power unit 26 for supplying emergency power. The further emergency power unit 26 can have, for example, a further electric vehicle that provides energy for at least one load at an output 28 through a further emergency power supply device of the configuration described here. An energy source 27 of the emergency power unit 26 is, in an exemplary embodiment, the traction battery of the further electric vehicle. Alternatively or additionally, the further emergency power unit 26 can be a diesel generator set or other fuel generator set. An energy source 27 of the emergency power unit 26 is, in the example of such a generator, the fuel of the fuel generator set.

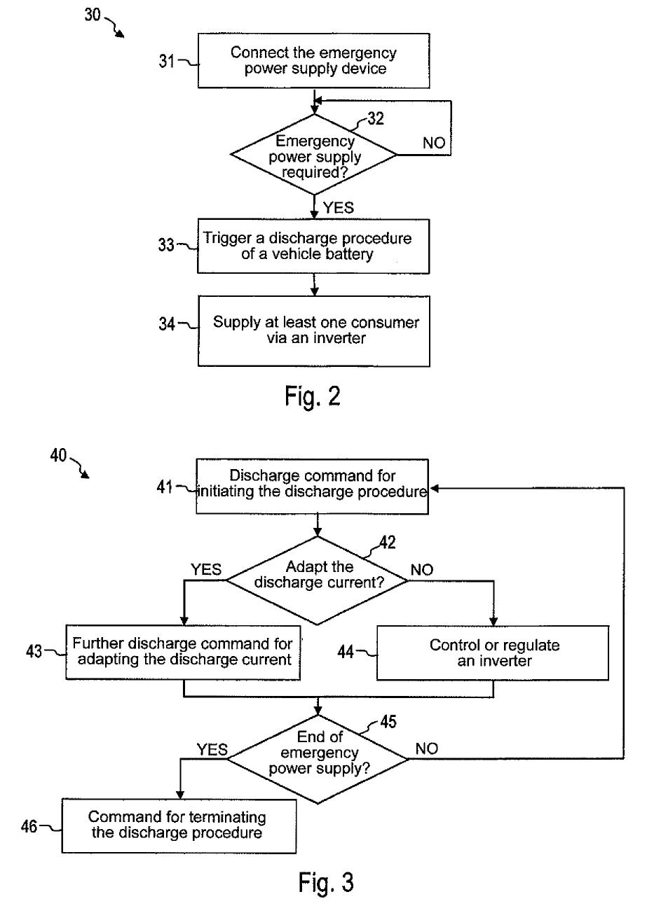

The emergency power supply device 10 can be equipped for a plurality of different processes for providing an emergency power supply. Example processes are described in more detail with reference to FIGS. 2 and 3.

FIG. 2 is a flow chart of an exemplary process 30 for supplying at least one electrical load. The process 30 can be implemented using an exemplary embodiment of the emergency power supply device. In step 31, the emergency power supply device 10 is connected to the charge/discharge plug 2 of the electric vehicle 1. In this case, the electric vehicle 1 can be completely separate from the electrical mains 20. In step 32, a monitoring occurs to determine if an emergency power supply is required for at least one load. To this end, a mains voltage and/or a mains current can be monitored. If there is no mains failure, monitoring can continue in step 32. If there is a mains failure, or an emergency power supply for at least one load is required for other reasons, the process can be continued in step 33. In step 33, a discharge procedure of the traction battery 5 of the electric vehicle 1 is triggered. An output 15 of the emergency power supply device is connected in electrically conductive manner to a mains plug 25 of at least one electrical load 21. In step 34, the at least one electrical load 21 is supplied with electrical energy by the emergency power supply device 10. An inverter 14 of the emergency power supply device 10 can receive a direct current from the traction battery 5 at the input side and can provide an alternating current for supplying the at least one electrical load 21 at the output side.

The emergency power supply device 10 can not only trigger the discharge procedure of the traction battery 5 during operation, but can influence it, for example, through at least one further discharge command, as described in more detail with reference to FIG. 3.

FIG. 3 is a flow chart of an exemplary process 40 for supplying at least one electrical load. The process 40 can be implemented automatically using an exemplary embodiment of the emergency power supply device. The generation of the discharge commands and the further functions described with reference to FIG. 3 can be implemented automatically by the control device 11 of the emergency power supply device. In step 41, the emergency power supply device 10 generates a discharge command for initiating a discharge procedure of the traction battery 5 of the electric vehicle. The emergency power supply device 10 relays the discharge command to the electric vehicle. The discharge command can be relayed as a power line communication through a charge/discharge plug 2 of the electric vehicle 1 or through a separate data interface of the electric vehicle 1. In step 42, a check is performed to determine if the discharge current of the traction battery, which is received by the emergency power supply device 10, should be changed. The check in step 42 can be implemented depending on a power consumption of the at least one load. The discharge current of the traction battery 5, which is received by the emergency power supply device 10, can be compared with a set value that depends upon the power consumption of the at least one electrical load 21. The check in step 42 can take place dependent upon a charge status of an energy storage 16 of the emergency power supply device 10. The discharge current of the traction battery 5, which is received by the emergency power supply device 10, can be decreased if a charge stored in the energy storage 16 approaches an upper threshold value. The discharge current of the traction battery 5, which is received by the emergency power supply device 10, can be increased if a charge stored in the energy storage 16 approaches a lower threshold value. If it is determined in step 42 that the discharge current should be changed, a further discharge command is generated in step 43 and relayed to the electric vehicle 1 in order to change the discharge current of the traction battery 5. The process is continued in step 45. If it is determined in step 42 that the discharge current should not be changed, an inverter of the emergency power supply device can be influenced in a control or regulating loop in step 44, so that the emergency power supply device 10 provides an alternating voltage at an output 15. The process is continued in step 45.

In step 45, a check is performed to determine if the emergency power supply should be terminated. To this end, for example, it is possible to monitor a user input at a user interface of the emergency power supply device 10. Alternatively or additionally, a load change at the output 15 of the emergency power supply device 10 can be monitored to determine whether the at least one load is switched off and/or is disconnected from the output 15 of the emergency power supply device 10. If it is determined in step 45 that the emergency power supply should not be terminated, the process can revert to step 41. If it is determined in step 45 that the emergency power supply should be terminated, a further command can be generated in step 46 and output to the electric vehicle 1 in order to terminate the discharge procedure.

Numerous further modifications of the processes and devices described can be implemented in further exemplary embodiments. For example, the emergency power supply device 10 can also be equipped to relay discharge commands for triggering a discharge procedure and/or for controlling a discharge procedure to the electric vehicle 1 not through the charge/discharge plug 2, but through a data interface that is separate therefrom. Alternatively, an energy transmission for discharging and/or charging the traction battery 5 can be effected as a PLC through a control pin of a charge/discharge plug 2.

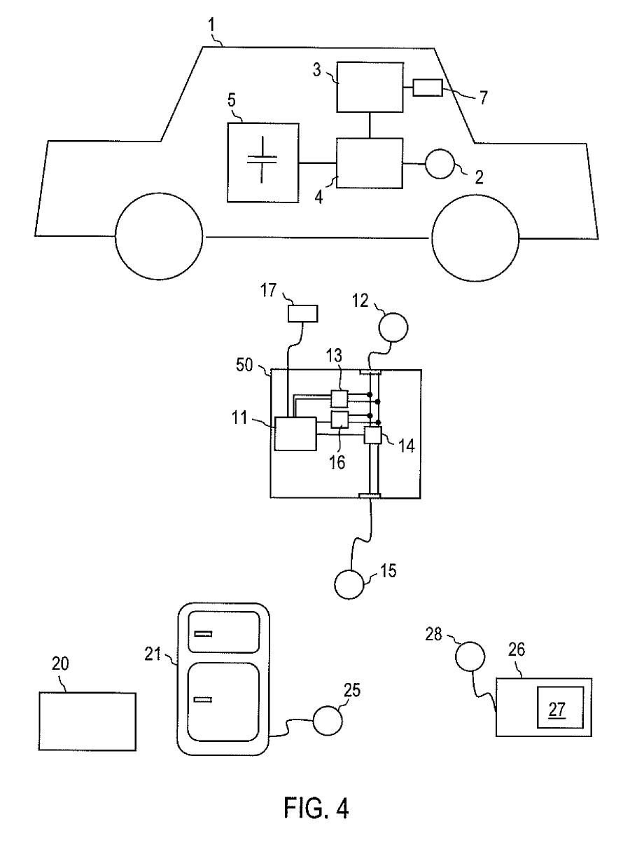

FIG. 4 shows a system comprising an electric vehicle 1 and an emergency power supply device 50. The electric vehicle 1 has a charge/discharge plug 2. The electric vehicle 1 has a data interface 7 that is separate from the charge/discharge plug 2. The control electronics 3 and/or the charge/discharge electronics 4 of the electric vehicle 1 can be coupled to the data interface 7 to evaluate and implement discharge commands received through the data interface 7.

The emergency power supply device 50 has an interface 12 to couple to the charge/discharge plug 2. The emergency power supply device 50 has an interface 17 separate from the interface 12 through which the discharge current is received at the charge/discharge plug 2 and through which the discharge command can be transmitted to the electric vehicle 1. The data interface 7 and the interface 17 of the emergency power supply device 50 can be configured for example as RS232 or USB interfaces. The further embodiment and mode of operation of the emergency power supply device 50 corresponds to that of the emergency power supply device 10.

While exemplary embodiments have been described in detail with reference to the figures, alternative or additional features can be applied in further exemplary embodiments. For example, whilst discharge commands for triggering a discharge procedure can be digital commands, the discharge commands can also be implemented as analog signals.

While, in some exemplary embodiments, the energy discharged at the traction battery can be fed to an inverter of the emergency power supply device, in further exemplary embodiments, the emergency power supply device does not have to comprise an inverter. For example, the electric vehicle itself can comprise an inverter. In such a case, the emergency power supply device can have an AC-DC converter to provide the emergency power supply for the at least one load.

While, in some exemplary embodiments, the emergency power supply device can be supplied with energy from the traction battery through the charge/discharge plug, at least during the discharge procedure, in further exemplary embodiments the emergency power supply device can also be fed from a separate battery or a separate accumulator during the discharge procedure of the traction battery.

While a charge/discharge plug can be used as a charge/discharge interface for charging and discharging the traction battery of the electric vehicle, it is also alternatively possible to use another form of charge/discharge interface. For example, when using an inductive coupling between the emergency power supply device and the electric vehicle, a wireless energy transmission can take place during the discharge procedure, which means that a plug contact becomes unnecessary.

The charge/discharge plug can be configured according to a suitable standardization (for example, IEC 62196). It is possible to provide a separate connecting contact for transmitting discharge commands. Alternatively or additionally, discharge commands can be transmitted in a PLC procedure through the connecting contacts, through which energy is also transmitted when charging and discharging the traction battery. During the charge or discharge procedure, it is possible for energy transmission to take place through control pins of the charge/discharge plug to realize a PLC.

While the traction battery can be discharged through a combined charge/discharge interface of the electric vehicle, the electric vehicle can also have mutually separate interfaces for the charge and discharge procedure.

Devices, processes and systems according to exemplary embodiments enable an emergency power supply to at least one electrical load. The traction battery of the electric vehicle is used here as an energy storage to ensure the supply of emergency power to the at least one electrical load.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems, apparatuses, and methods as defined by the following claims.

What is claimed is:

1. An emergency power supply device for providing emergency power for at least one electrical load, wherein:
the emergency power supply device is configured to couple to a discharge interface of an electric vehicle; and
the emergency power supply device is configured to supply the emergency power for the at least one electrical load by discharging a traction battery of the electric vehicle.

2. The emergency power supply device according to claim 1, which further comprises an interface outputting a discharge command to the electric vehicle.

3. The emergency power supply device according to claim 2, wherein:
the discharge interface of the electric vehicle is a combined charge/discharge interface; and
the interface is equipped to couple to the charge/discharge interface of the electric vehicle.

4. The emergency power supply device according to claim 2, wherein the interface is configured to couple to a data interface of the electric vehicle.

5. The emergency power supply device according to claim 2, wherein the emergency power supply device is configured to generate the discharge command according to a V2G protocol.

6. The emergency power supply device according to claim 1, which further comprises an inverter configured to receive a discharge current of the traction battery and to generate an alternating current for providing the supply of emergency power.

7. The emergency power supply device according to claim 6, wherein the inverter has an output and which further comprises a socket connected to the output of the inverter and shaped to connect to a mains plug of the at least one electrical load.

8. The emergency power supply device according to claim 1, which further comprises an energy storage configured to be charged by the traction battery of the electric vehicle and to be discharged at least during a time interval in which a discharge current of the traction battery is decreased to provide supply of the emergency power for the at least one electrical load.

9. The emergency power supply device according to claim 1, wherein the at least one electrical load can be connected directly to the emergency power supply device.

10. The emergency power supply device according to claim 1, wherein the emergency power supply device is configured to provide the supply of emergency power for the at least one electrical load without mains impedance monitoring.

11. The emergency power supply device according to claim 1, wherein the emergency power supply device is a portable device.

12. An emergency power supply device for providing emergency power for at least one external electrical load from an electric vehicle having a traction battery connected to a discharge interface, the emergency power supply device comprising:
a power controller;
a vehicle interface shaped to couple to the discharge interface of the electric vehicle and, when electrically coupled thereto, to receive power from the traction battery through the discharge interface, the vehicle interface electrically connected to the power controller;
a power supply circuit electrically connected to at least one of the power controller and to the vehicle interface; and
an output electrically connected to at least one of the power controller, the vehicle interface, and the power supply circuit to supply output power to the external electrical load when electrically connected to the output, the power supply circuit controlling the supply of power sent to the output.

13. The emergency power supply device according to claim 12, which further comprises an inverter electrically connected to at least one of the power controller and the output and configured to receive a discharge current of the traction battery and to generate an alternating current at the output to provide an emergency power supply.

14. The emergency power supply device according to claim 13, wherein the inverter has an output and which further comprises a mains socket electrically connected to the output of the inverter and shaped to connect to a mains plug of the at least one electrical load.

15. A system, comprising
at least one electric vehicle having a traction battery,
at least one electrical load; and
at least one emergency power supply device according to claim 1 and configured to be coupled to the at least one electric vehicle and the at least one electrical consumer.

16. A process for providing an emergency power supply to at least one electrical load, which comprises:
coupling an emergency power supply device to a discharge interface of an electric vehicle in the event of a failure of an electrical mains; and
supplying the at least one electrical load with power by discharging a traction battery of the electric vehicle through the emergency power supply device.

17. A process for providing an emergency power supply to at least one electrical load, which comprises:
coupling the emergency power supply device according to claim 1 to a discharge interface of an electric vehicle in the event of a failure of an electrical mains; and
supplying the at least one electrical load with power by discharging a traction battery of the electric vehicle through the emergency power supply device.
